(19) United States
(12) Patent Application Publication
(10) Pub. No.: US 2012/0143718 A1
(43) Pub. Date: Jun. 7, 2012

(54) OPTIMIZATION OF A WEB-BASED RECOMMENDATION SYSTEM

(75) Inventors: Stephen E. Graham, Somerville, MA (US); Mary Catherine Graham, Washington, DC (US); Moshe Ben-Akiva, Brookline, MA (US); Adam M. Roberts, Cambridge, MA (US); Xiaojing Li, Cambridge, MA (US); Vaibhav Rathi, Cambridge, MA (US); Sanjib Mohanty, Sudbury, MA (US)

(73) Assignee: ChoiceStream, Inc., Cambridge, MA (US)

(21) Appl. No.: 12/959,745

(22) Filed: Dec. 3, 2010

(51) Int. Cl. G06Q 30/00

(52) U.S. Cl. 705/26.7

(57) ABSTRACT

A method for determining product recommendations to be presented to users includes forming, by a formula generation module, a plurality of different recommendation formulas, including, for each recommendation formula, assigning a weight to at least some of a plurality of recommendation characteristics, wherein each recommendation characteristic is representative of at least one of a characteristic of a product, a characteristic of a method for presenting the product recommendations to the users, and a characteristic of a user. The method further includes iteratively performing the steps of: for each of the plurality of recommendation formulas, selecting, by a product recommendation module, at least one product for presentation to the users on the basis of the corresponding recommendation formula; sending, by a communications module, instructions to a server to present the selected product to the users; receiving, by a data evaluation module, data representative of user responses to each of the products presented to the users; evaluating, by the data evaluation module, the received data; and selecting, using the data evaluation module, a subset of the recommendation formulas included in the plurality of recommendation formulas on the basis of the evaluation of the collected data.

### BACKGROUND

In web-based commerce, product recommendations are often displayed to a user based on characteristics of a product the user is viewing or has viewed or based on characteristics of the user.

### SUMMARY

In a general aspect, a method for determining product recommendations to be presented to users includes forming, by a formula generation module, a plurality of different recommendation formulas, including, for each recommendation formula, assigning a weight to at least some of a plurality of recommendation characteristics, wherein each recommendation characteristic is representative of at least one of a characteristic of a product, a characteristic of a method for presenting the product recommendations to the users, and a characteristic of a user. The method further includes iteratively performing the steps of: for each of the plurality of recommendation formulas, selecting, by a product recommendation module, at least one product for presentation to the users on the basis of the corresponding recommendation formula; sending, by a communications module, instructions to a server to present the selected product to the users; receiving, by a data evaluation module, data representative of user responses to each of the products presented to the users; evaluating, by the data evaluation module, the received data; and selecting, using the data evaluation module, a subset of the recommendation formulas included in the plurality of recommendation formulas on the basis of the evaluation of the collected data.

Embodiments may include one or more of the following.

The characteristic of the method for presenting the product recommendations to the user includes at least one of a degree of variety in the presented product recommendations, a degree of randomization of the presented product recommendations, and a degree of filtering of the presented product recommendations.

The characteristic of a user includes at least one of a purchasing history of the user, a browsing history of the user, and a demographic characteristic of the user. Forming the plurality of recommendation formulas includes determining a length in time of at least one of the purchasing history of the user and the browsing history of the user.

Selecting at least one product includes selecting at least one product further on the basis of a characteristic of the product.

Receiving data representative of user responses includes receiving data representative of a performance metric. The performance metric includes at least one of a click through rate, a click conversion rate, a click purchase rate, a click revenue, a view through conversion rate, a view through purchase rate, a click average order size, a view through average order size, a view through revenue, and a total revenue.

Evaluating the received data includes evaluating the data on the basis of a performance metric. The performance metric includes at least one of a click through rate, a click conversion rate, a click purchase rate, a click revenue, a view through conversion rate, a view through purchase rate, a click average order size, a view through average order size, a view through revenue, and a total revenue. Evaluating the received data includes identifying at least one recommendation formula for which a value associated with the performance metric of the collected data corresponding to the at least one identified recommendation formula is less than a predetermined threshold value.

Selecting the subset of the recommendation formulas including eliminating the at least one recommendation formula for which the value associated with the performance metric of the collected data corresponding to the selected at least one recommendation formula exceeds the predetermined threshold value. The value associated with the performance metric is a confidence level representative of a relative standing of the performance metric. Evaluating the received data includes identifying at least one recommendation formula for which the performance metric of the collected data corresponding to the identified at least one recommendation formula is below a predetermined threshold value.

Evaluating the received data includes: fitting a surface to the collected data; and smoothing the surface. The surface is representative of a value of a performance metric associated with each of the plurality of recommendation formulas.

The method further includes, for each of the subset of the recommendation formulas, selecting, by the product recommendation module, at least one product for presentation to the users on the basis of the corresponding recommendation formula. The method further includes accepting, at the formula generation module, the plurality of recommendation characteristics.

In another general aspect, a system for determining product recommendations to be presented to users includes a formula generation module configured to form a plurality of different recommendation formulas, including, for each recommendation formula, assigning a weight to at least some of a plurality of recommendation characteristics, wherein each recommendation characteristic is representative of at least one of a characteristic of a product, a characteristic of a method for presenting the product recommendations to the users, and a characteristic of a user. The system further includes a product recommendation module configured to select, for each of the plurality of recommendation formulas, at least one product for presentation to the users on the basis of the corresponding recommendation formula; and a communications module configured to send instructions to a server to present the selected product to the users. The system also includes a data evaluation module configured to perform the steps of receiving data representative of user responses to each of the products presented to the users; evaluating the received data; and selecting a subset of the recommendation formulas included in the plurality of recommendation formulas on the basis of the evaluation of the collected data.

Among other advantages, the methods and systems described herein allow the products recommended to a user browsing a website to be tailored to the user's purchasing or browsing interests and/or demographic characteristics. This targeting of displayed recommendations in turn allows an owner of the website to increase product views, purchase rate, revenue, or other metrics.

Optimal settings for the generation of the product recommendations are based on observations of real user behavior and thus accurately reflect the anticipated performance of the recommendation system.

Data representative of user responses to the recommendations are processed efficiently and simultaneously, allowing high speed determination of the effectiveness of various recommendation strategies. A smoothing procedure is used to reduce the effect of noise.

Other features and advantages of the invention are apparent from the following description and from the claims.

### BRIEF DESCRIPTION OF DRAWINGS

FIG. 1 is a block diagram of a recommendation-based system.

FIG. 2 is a block diagram of a recommendation-based system.

FIG. 3 is a block diagram of a recommendation system.

FIG. 4 is a flow chart for the generation of recommendations.

FIG. 5 is a block diagram of an exemplary formula generation module.

FIG. 6 is a flow chart for the evaluation of recommendation formulas.

FIG. 7 is an exemplary surface used for the evaluation of recommendation formulas.

### DETAILED DESCRIPTION

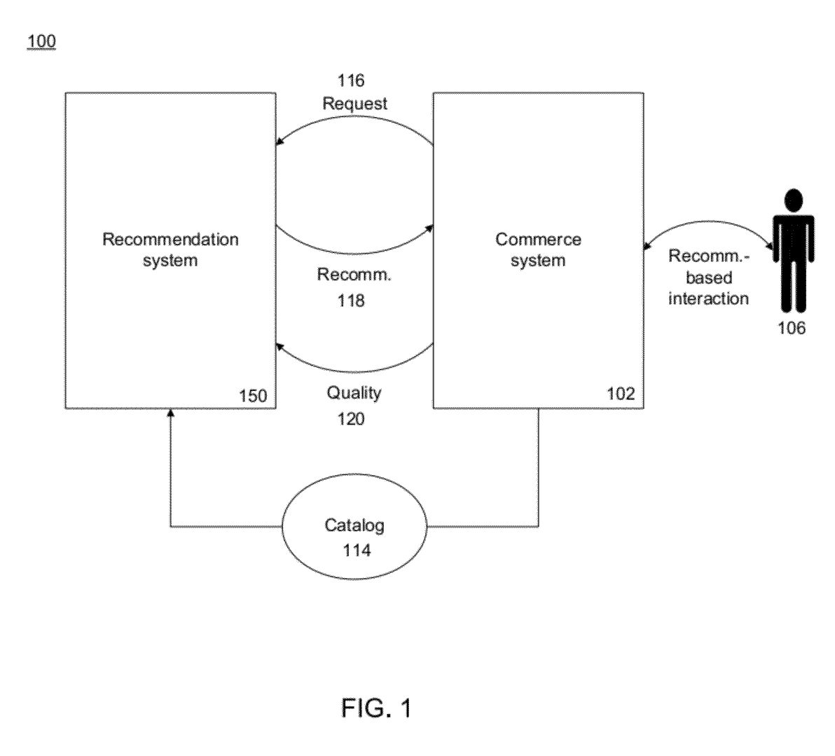

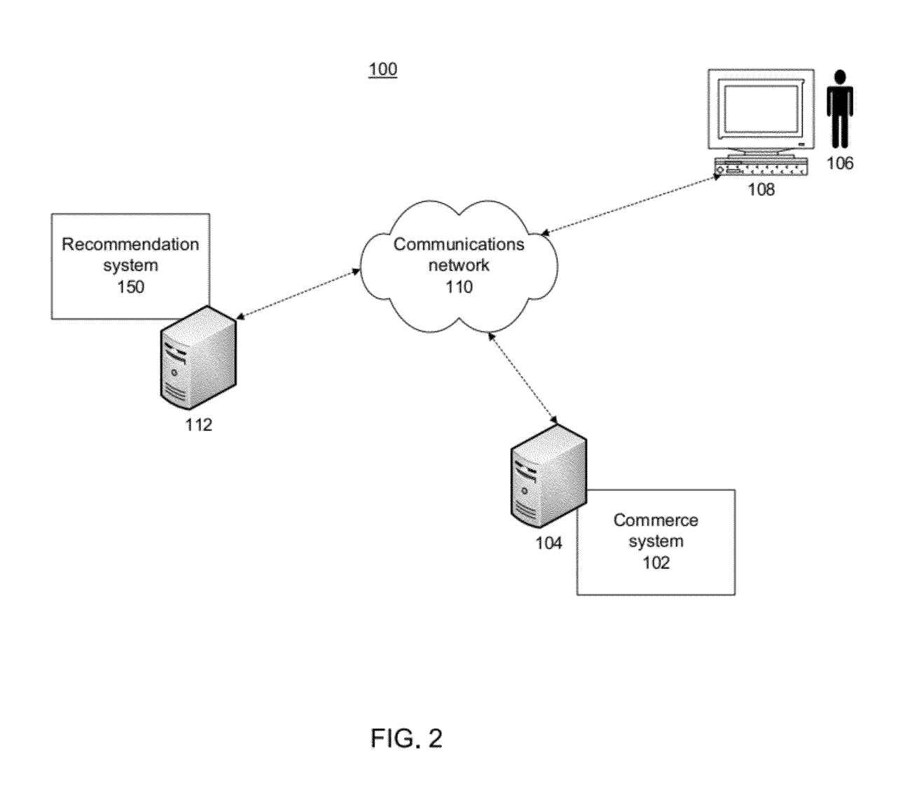

Referring to FIGS. 1 and 2, in a recommendation-based system 100, a commerce system 102 hosted on a server 104 displays or sells products and/or services to a user 106. Commerce system 102 may sell, for instance, movies, music albums, books, games, apparel, or recreational travel; or may display information about, e.g., current events or local restaurants. User 106 interacts with commerce system 102 via a user interface 108, such as a computer, connected to server 104 via a communications network 110 (e.g., the Internet).

In general, commerce system 102 interacts with a recommendation system 150 hosted on another server 112 via communications network 110 in order to obtain recommendations for products or services to be presented to user 106. Commerce system 102 initially provides recommendation system 110 with a catalog 114 of recommendable items (i.e., products or services that are available to be recommended to user 106). Simultaneously with or subsequent to providing catalog 114, commerce system 102 sends a request 116 to recommendation system 150 for one or more recommendable items to be displayed to user 106. The recommendation system determines recommendations 118 and returns the recommendations to commerce system 102. Commerce system 102 displays some or all of the recommendations to the user and collects quality data 120 indicative of the user's interaction with the recommendations, such as whether the user clicked on or purchased any of the recommendable items. The quality data 120 is returned back to recommendation system 150, where it is used to optimize the algorithm used in the generation of recommendations 118, as discussed in greater detail below.

Request 116 includes an identifier of user 106 (e.g., in the form of a cookie) and an identifier of the particular commerce system 102 (e.g., an Application Programming Interface (API) key). The request may also include the user's browsing and/or purchasing history in commerce system 102 (and, in some cases, in related commerce systems) and the browsing and/or purchasing history of other users of commerce system 102. Additionally, the request may include demographic characteristics of the user, such as the user's age, gender, income level, or geographic location. Alternatively, such demographic characteristics are stored in association with the user's identifier in a database in recommendation system 150.

Recommendation system 150 identifies recommendations 118 on the basis of characteristics of user 106, characteristics of the recommendable items in catalog 114, and/or characteristics of the product or service currently being viewed by the user. Recommendation system 150 also utilizes the collective behavior of multiple users (e.g., pools of users or simply “user pools”) to aid in the identification of recommendations 118. In some implementations, users are assigned to user pools at random and a user stays in a user pool until user pool weights are adjusted (as described in more detail below). An iterative process is used to improve the ability of recommendation system 150 to identify relevant recommendations (i.e., so that the recommendations include items that the user would value highly and be likely to view and/or purchase).

Specifically, recommendation system 150 determines a formula to identify recommendable items that will achieve a goal of commerce system 102. The formula, discussed in more detail below, may include quantitative and/or qualitative inputs related to user characteristics, characteristics of the recommendable items, display characteristics, and other factors. For instance, commerce system 102 may have as a goal to increase or maximize one or more objective functions such as click-through rate (CTR), click conversion rate (CCVR), click purchase rate (CPR), click revenue (CR), view-through conversion rate (VCVR), view-through purchase rate (VPR), click average order size (CAOS), view-through average order size (VAOS), view-through revenue (VR), or total revenue (TR). More generally, commerce system 102 may aim to optimize any objective function that is computable from the quality data 120. As discussed in more detail below, recommendation system 150 generates recommendations 118 to be presented to users of commerce system 102. Based on quality data obtained from a plurality of users, the recommendation system then determines the value of the target one or more objective functions. Through an iterative process of providing recommendations and evaluating the resulting quality data, the recommendation system identifies a specific formula that optimizes the value of the target objective function(s).

### 1 RECOMMENDATION GENERATION

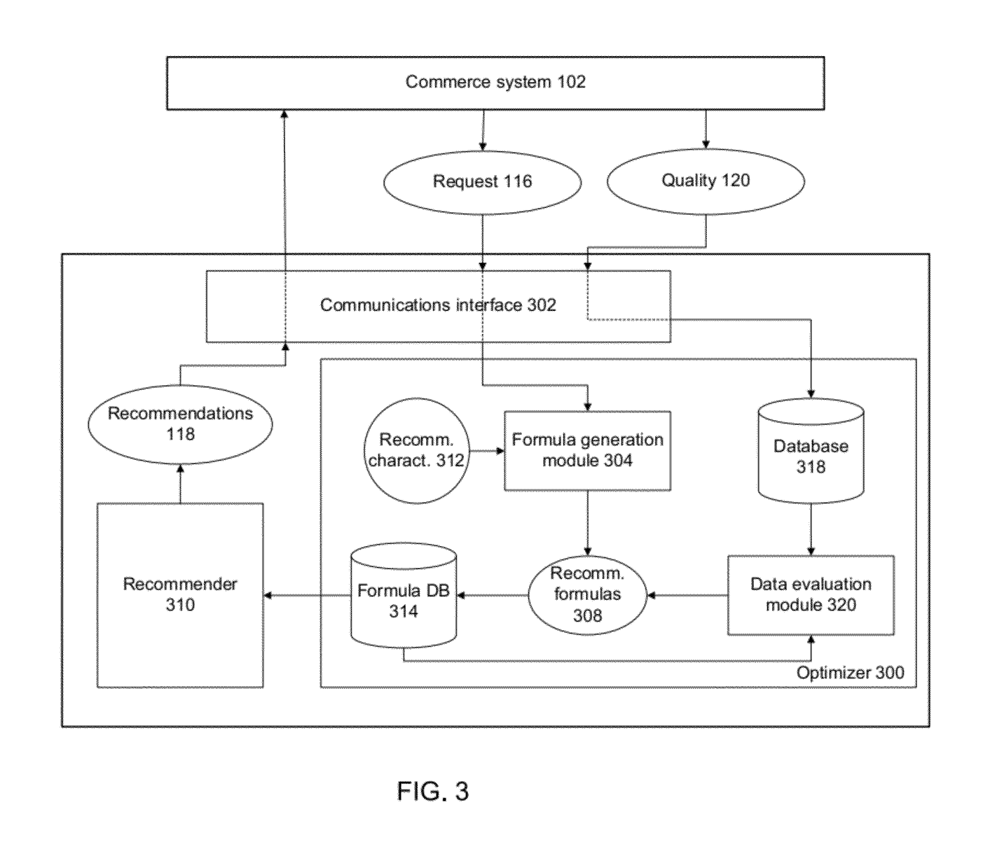

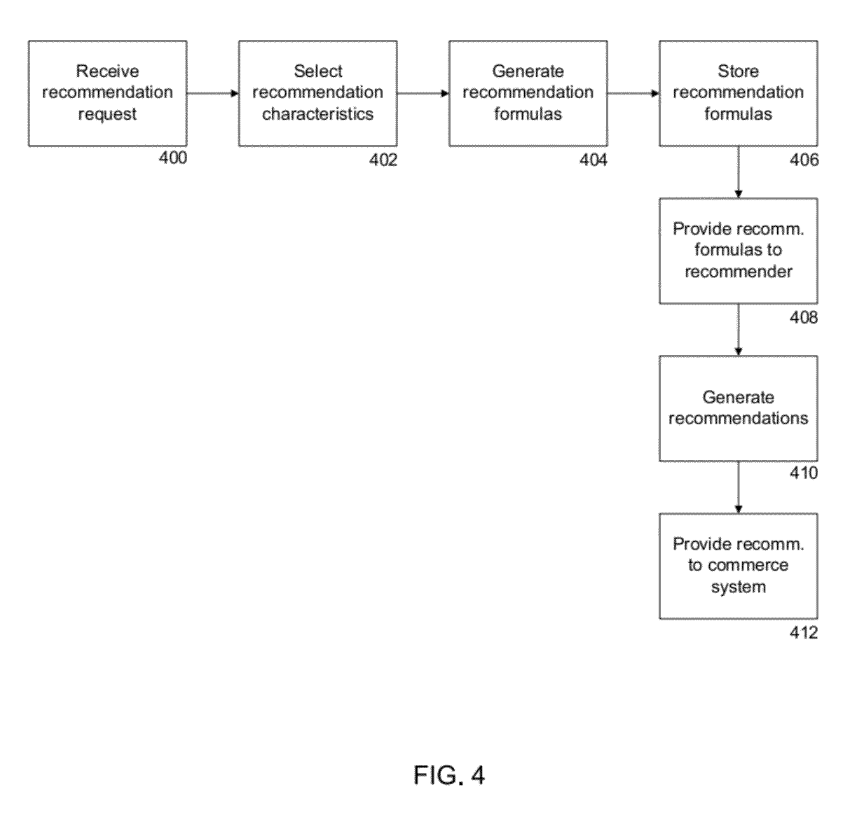

Referring to FIGS. 3 and 4, in general, recommendation system 150 receives a recommendation request 116 from commerce system 102 via a communications interface 302 (step 400). The recommendation request is passed to an optimizer 300, whose objective is to identify one or more combinations of recommendation characteristics (discussed below) that predict effective recommendations in terms of the target objective function. Optimizer 300 includes a formula generation module 304, which generates a set of recommendation formulas 308 that will be used by a recommender 310 to produce recommendations 118.

Each recommendation formula 308 is based on recommendation characteristics 312. Recommendation characteristics are elements used to identify recommendations for a user or to determine the manner in which the recommendations are displayed to the user. Recommendation characteristics may be attributes of the recommendable items, such as price buckets or product category (e.g., books, apparel, or housewares). The recommendation characteristics may also be user characteristics, such as the browsing or purchasing history of the user or demographic characteristics of the user. A recommendation characteristic may also include a characteristic that depends on relationships between user characteristics and/or user history and characteristics of the recommendable items. The recommendation characteristics may also be characteristics of the way in which the recommendations are presented to the user, such as whether the recommendations are shuffled or filtered before presentation, or the degree of variety in the attributes of the presented recommendations (e.g., the breadth of the price range of the recommendable items). A recommendation characteristic may correspond to a creative element, which captures aspects related to the display of recommendations, such as visual aspects (e.g., background color), lag time between images for multiple recommendations, and messages associated with recommendations (e.g., labeling recommendations as “People Who Liked This Purchased” versus “Customers Who Liked This Also Purchased”).

In some cases, optimizer 300 selects certain recommendation characteristics to be used in the generation of recommendation formulas for a particular commerce system 102 (step 402). In other cases, the recommendation characteristics 312 to be used for a particular commerce system are identified by an operator, such as a manager of recommendation system 110. The operator selects the recommendation characteristics on the basis of the operator's prior experience and/or knowledge about the products or services offered by that commerce system. In general, recommendation characteristics are selected to induce user responses that will provide relevant information about an optimal set of recommendation characteristics. The process of determining an ideal set of recommendation characteristics is iterative, as discussed below, and thus it is often advisable to start with a relatively complete list of recommendation characteristics in order to induce the generation of an adequate amount of data.

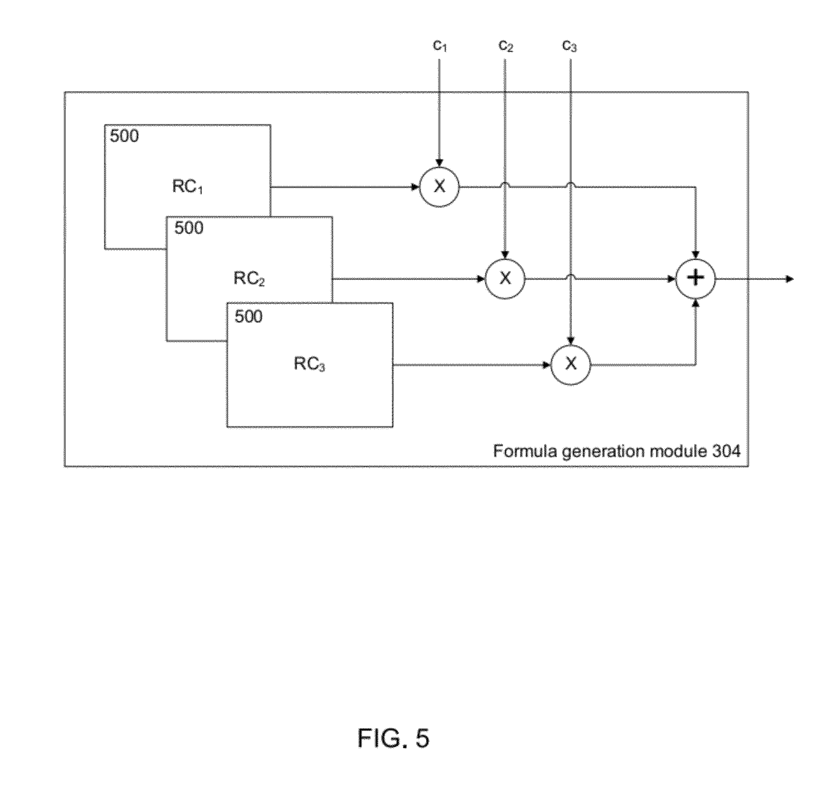

Each recommendation formula 308 is a unique combination of at least some of the recommendation characteristics 312 selected for the particular commerce system (step 404). Referring to FIG. 5, in one example, formula generation module 304 includes multiple recommendation characteristic engines 500, each of which corresponds to a particular recommendation characteristic RCᵢ. A value is output from each recommendation characteristic engine indicative of the value of the recommendation characteristic for a particular recommendable item. Each output value is weighted by an importance coefficient cᵢ. A mathematical recommendation formula corresponding to the overall recommendation formula 308 generated by formula generation module 304 is the sum of the weighted output values. That is, the mathematical recommendation formulas in a set differ only by the weights of the constituent recommendation characteristics. In some cases, interactions between different recommendation characteristics may also be included in the mathematical recommendation formulas. In other instances, in a given set of mathematical recommendation formulas, one or more recommendation characteristics may be assigned a constant importance characteristic throughout all of the recommendation formulas in the set. Various other ways of developing a set of recommendation formulas are also conceivable. For instance, in many cases, some or all of the recommendation characteristics influence the recommendation set as a whole or the presentation of the recommendation set without producing a numerical output value. The set of recommendation formulas is stored in a formula database 314 (step 406).

The set of recommendation formulas is provided to recommender 310 (step 408), which generates recommendations 118 based on each of the recommendation formulas in the set (step 410). In some cases, a user pool weight is assigned to each recommendation formula in the set to allocate a predetermined percentage to recommendations generated based on each of the recommendation formulas. The user pool weights may be uniform or may vary based on expected or actual performance of each recommendation formula. The generated recommendations are then provided via an output interface 316 to the commerce system (step 412), which displays the recommendations to the user.

### 2 DATA EVALUATION

Quality data 120 indicative of the user's interaction with the recommendations, such as whether the user clicked on or purchased any of the recommendable items, is returned to the recommendation system 150 via input interface 302 and stored a database 318 (e.g., an extract, transform, and load (ETL) database). Database 318 stores granular data broken down at the level of, e.g., date or set of recommendation formulas. The database also includes metrics such as the number of impressions or clicks or the revenue generated for each recommendation formula in the set, allowing any of a variety of objective functions to be calculated for the stored data.

A data evaluation module 320 evaluates the quality data in terms of the desired objective function. Certain recommendation formulas 308 are eliminated from the set based on estimated values for the target objective function (discussed in greater detail below). The user pool weights are adjusted such that user traffic is reallocated to recommendations generated based on the recommendation formulas remaining in the set. In some instance, the actual performance of each recommendation formula is also taken into account when determining which recommendation formulas to eliminate.

The process of continuous optimization is iterative and evolves to a more focused set of recommendation formulas that approach or achieve a desired outcome for one or more target objective functions. In some instances, the process proceeds until a predetermined number of recommendation formulas remain in the set. In other instances, the process proceeds until a plateau in the performance of the remaining recommendation formulas is reached. In some cases, new recommendation formulas may also be added as other formulas are removed from the set.

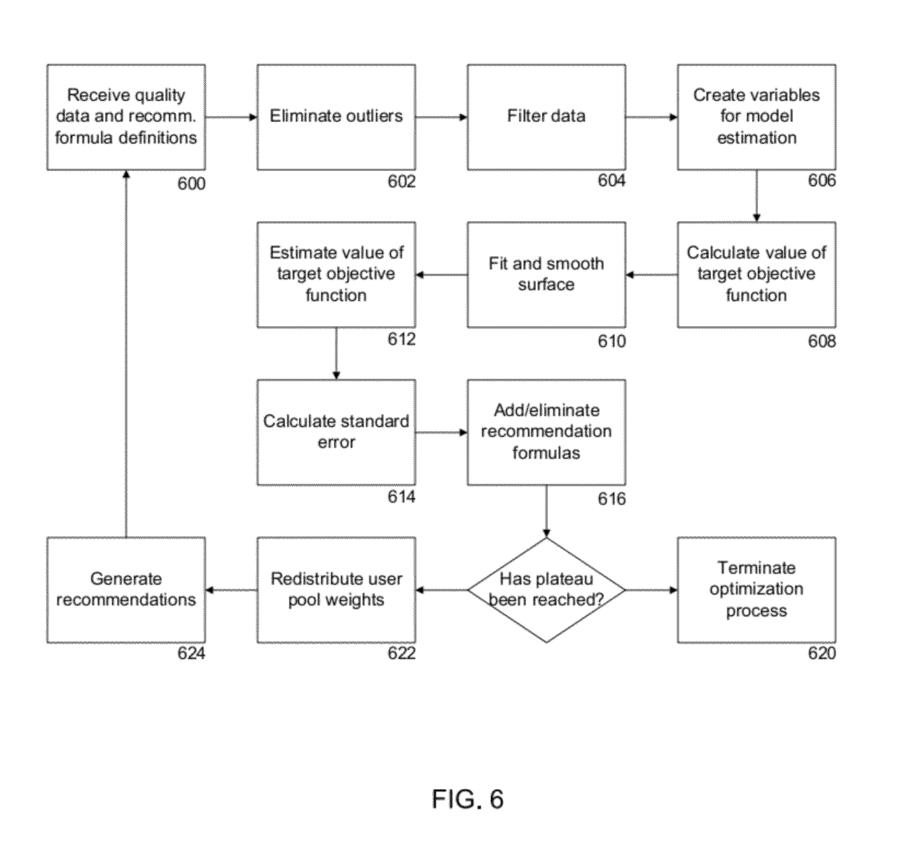

More specifically, referring to FIGS. 3 and 6, the data evaluation module 320 receives quality data 120 from database 318 and recommendation formula definitions from formula database 314 (step 600). Database 318 contains an entry corresponding to each combination of a recommendation formula and a value of any nuisance variables, if any. Very generally, nuisance variables are variables that aid in the description of behavior in the objective function but are not within the control of the recommendation-based system 100. Examples of nuisance variables include user type and day of the week. Outliers in the data, if present, are eliminated prior to detailed analysis of the data (step 602). If prior results for CTR, CCVR, CAOS, CPR, VCVR, VAOS, VPR, or other objective functions are to be evaluated along with current data corresponding to a particular set 306 of recommendation formulas, artificial data corresponding to the relevant prior results are created, taking into account user pool weights for the recommendation formulas associated with the prior results.

The data, including prior results, are filtered based on any of a variety of criteria (step 604). For instance, user type data filters may be implemented in order to target the optimization to a particular population segment (e.g., an age group). As another example, a date window filter may be used to focus the optimization on results obtained within a particular date range. Using the date window filter allows only data collected after a relevant market event (such as the introduction of a new product) to be included in the evaluation of the performance of the recommendation formulas. In some embodiments, a recommender filter may also be used to specify which of multiple potential recommenders are to be considered in the optimization process. For instance, a “People Who Liked This Purchased” recommender may be used on a product detail page, while a different recommender may be used to provide personalized recommendations on a category page.

Once the data have been filtered, variables are created for the model estimation procedure (step 606). These variables include dummy variables for the nuisance variables, first-order variables corresponding to the recommendation characteristics, and second-order variables representative of interactions among different recommendation characteristics.

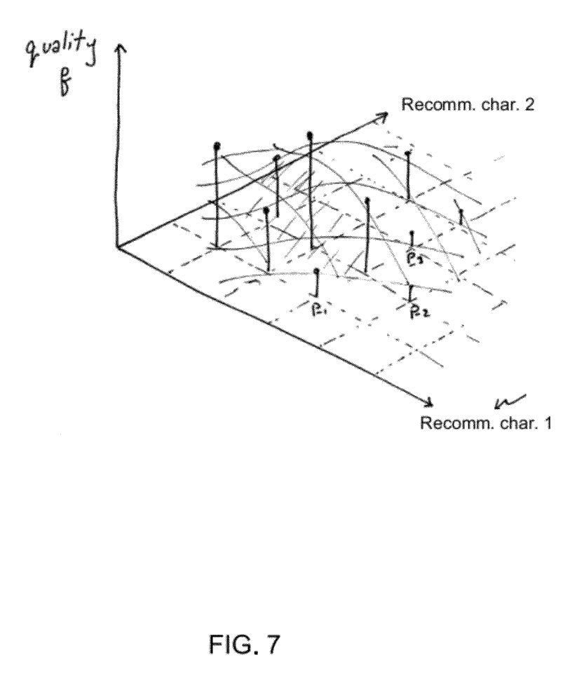

The value of the target objective function is calculated for each entry in database 318 and, if relevant, for each prior result (step 608). Specifically, referring also to FIG. 7, the performance of the set of recommendation formulas 308 is evaluated by parameterizing the weights of the recommendation characteristics and fitting a surface to the values of the objective function for each recommendation formula (step 610). The surface predicts the quality of the recommendations generated by each recommendation formula. The surface is smoothed to reduce or eliminate the effects of variations that may be due, for instance, to small sample size effects. The curve fitting is performed via estimation techniques such as regression (e.g., a stepwise regression), using the target objective function as the dependent variable. Based on the results of the curve fitting and smoothing, the values of the target objective function can be estimated (step 612). The standard error for each prediction is then calculated by comparing the estimated values of the target objective function with the corresponding values calculated directly based on user response data (step 614).

Based on the results of the curve fitting and smoothing, one or more poorly performing recommendation formulas 308 are eliminated from the set (step 616). For instance, a confidence level may be selected and used as an elimination rule. An additional elimination condition may also be applied when the target objective function is a rate, based on the assumption that the objective functions have a binomial distribution. The confidence level is representative of the degree of certainty that a given recommendation formula performs worse than the top-performing recommendation formula(s). For instance, the 90^{th} percentile predicted value of the recommendation formulas is identified and the confidence level is set at 98%. Normality assumptions are then used to determine the confidence that the predicted value for any given recommendation formula is less than the 90^{th} percentile predicted value. If the confidence level for a particular recommendation formula is greater than 98% (that is, there is a98% degree of confidence that the particular recommendation formula performs worse than the 90^{th} percentile), that recommendation formula is eliminated. In some cases, additional recommendation formulas 308 may be added to the set, with recommendation characteristic weights selected based on the analysis of the previous set of recommendation formulas.

If at least one recommendation formula is added or eliminated, the user pool weights are adjusted such that the eliminated recommendation formula(s) has a weight of 0 and the newly available weights are distributed as evenly as possible among the remaining recommendation formulas (step 622). Any remainder is divided up in a round-robin fashion to the recommendation formulas with the highest estimated values for the target objective function. New recommendations are generated on the basis of the remaining recommendation formulas, user response data is collected, and the evaluation restarts a further iteration (step 624).

If, however a plateau in the performance values has been reached, the optimization process is terminated (step 620) and the subset of recommendation formulas 308 that still remain in set 306 are deemed successful for use in production (i.e., in the generation of recommendations for display to users).

In some cases, an operator of the recommendation system may become aware of a market event or other event that can potentially impact some or all of the recommendation formulas in the set. For instance, the highly anticipated release of a new electronic reading device may affect the performance of recommendation formulas for a book-selling website or an electronics website. In other cases, although the operator may be unaware of any particular event, the performance of the recommendation formulas may display a sudden and drastic change (e.g., the click-through rate has decreased, or previously promising recommendation formulas no longer perform well). Regardless of the operator's knowledge of any specific market event, it may be beneficial to restart the iterative narrowing process from a complete set of recommendation formulas, as the recommendation formulas remaining in the set after a partial or complete round of iterations may no longer reflect the best-performing combinations of recommendation characteristics. Alternatively, the date range filter may be applied to change the history length of the data included in the evaluation.

### 3 EXAMPLE

In one specific example, the objective function to be optimized is the click-revenue per on thousand recommendations called. The recommendation characteristics to be considered include the following, combinations of which are listed in Table 1:
1. Price buckets of items having a relative price of <50% (A1), 50-125% (A2), or >125% (A3) relative to the item being viewed by the user (no price bucket boosting is denoted as A0);
2. Correlation type: item view-to-purchase (B1), purchase-to-purchase (B2), or purchase-to-purchase within the same market basket (B3), where no correlation is denoted as B0;
3. Time window for correlations: 30 days (C1), 90 days (C2), 180 days (C3), or not applicable C0;
4. Low (D1), or high (D2), or not applicable (D0) correlation scoring boost; and
5. Correlation algorithm history consideration. That is, each user's activities are correlated within the given time window (E1), within the same day (E2), or not applicable (E0).

Recommendation formulas are generated based on various combinations of the above recommendation characteristics; for this particular example, 69 of those recommendation formulas were selected for inclusion in the optimization procedure. Date and user type were used as covariates, and the confidence level was set at 98%. Three days of data, including metrics (i.e., objective functions), were retrieved from the database, which is disaggregated by day, recommendation formula, etc. Variables for the model estimation were created and the target objective function (click revenue per 1000 recommendations) was calculated for each row in the database.

A regression was performed and the objective function was then predicted using the model. A partial listing of results is given in Table 1. The first column lists an identifier of the recommendation formula. The second column, is_active, indicates whether the recommendation formula is “live” (that is, in production). The third column, is_good, indicates whether the recommendation formula should be kept for the next iteration. The next column, conf, indicates the level of confidence that the recommendation formula in that row is worse than the top-performing recommendation formula, using the estimated value, estimated error, and normality assumptions. In this case, with a confidence level of 98%, all the recommendation formulas with a value of 0.98 or more are targeted for elimination and thus are marked with is_good=0. The columns obs_metric and cleaned_metric give the actual values of the objective function before and after outliers are removed, respectively. The est_value column is the estimated value of the objective function as determined from the regression, and the num_obs column indicates the total number of observations for the given recommendation formula.

TABLE 1
Selected results of an exemplary optimization process.

| Rec. formula | is_active | is_good | conf | obs_metric | cleaned_metric | est_value | num_obs |
|---|---|---|---|---|---|---|---|
| A0B1C3D2E1 | 1 | 1 | 0.033578 | 0.1384863 | 0.1384863 | 0.078341 | 9,896 |
| A2B3C2D2E0 | 1 | 1 | 0.14617 | 0.0788325 | 0.0788325 | 0.06947 | 10,244 |
| A2B1C3D2E2 | 1 | 1 | 0.168795 | 0.1052417 | 0.1052417 | 0.065194 | 10,052 |
| A2B1C3D2E1 | 1 | 1 | 0.170743 | 0.0066158 | 0.0066158 | 0.064439 | 10,425 |
| A0B1C3D2E2 | 1 | 1 | 0.196496 | 0.026475 | 0.026475 | 0.063678 | 10,139 |
| A2B3C3D2E0 | 1 | 1 | 0.31766 | 0.0481173 | 0.0481173 | 0.057847 | 10,161 |
| A2B1C2D2E1 | 1 | 1 | 0.474749 | 0.032258 | 0.032258 | 0.0502 | 10,177 |
| A0B1C1D2E1 | 1 | 1 | 0.529065 | 0.0090107 | 0.0090107 | 0.047949 | 10,149 |
| A2B1C2D1E1 | 1 | 1 | 0.581593 | 0.0349421 | 0.0349421 | 0.044012 | 10,016 |
| A0B1C2D2E1 | 1 | 1 | 0.609043 | 0.0305293 | 0.0305293 | 0.044491 | 10,581 |
| A1B3C3D2E0 | 1 | 0 | 0.989557 | 0 | 0 | 0.004436 | 10,172 |
| A3B1C2D2E2 | 1 | 0 | 0.991865 | 0.0168812 | 0.0168812 | 0.009734 | 9,478 |
| A1B3C1D2E0 | 1 | 0 | 0.993487 | 0.0023145 | 0.0023145 | 0.003046 | 9,877 |
| A1B2C3D2E1 | 1 | 0 | 0.993988 | 0.0013302 | 0.0013302 | 0.003389 | 9,758 |
| A2B1C1D1E1 | 1 | 0 | 0.994263 | 0.0064974 | 0.0064974 | 0.002499 | 9,847 |
| A0B2C2D2E2 | 1 | 0 | 0.994317 | 0.0056541 | 0.0056541 | 0.007201 | 9,708 |
| A0B3C1D2E0 | 1 | 0 | 0.995953 | 0.0068567 | 0.0068567 | 0.002731 | 10,018 |
| A1B1C2D2E2 | 1 | 0 | 0.996092 | 0.0072545 | 0.0072545 | 0.000313 | 10,151 |
| A3B1C3D1E1 | 1 | 0 | 0.996598 | 0.0024853 | 0.0024853 | 0.000338 | 9,834 |
| A0B0C0D0E0 | 1 | 0 | 0.998203 | 0.0114022 | 0.0114022 | 0.020458 | 214,095 |

Based on the results in Table 1, user traffic is reallocated to the recommendation formulas having an as_good value of 1. The evaluation process is iteratively repeated until a plateau is reached or another termination condition is met.

In some embodiments, the process of iterative narrowing of results can be applied to other web-based implementations, such as rank ordering of results of a search engine.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the techniques described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques described herein can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact over a communication network. The relationship of client and server arises by virtue of computer programs running on the respective computers and having a client-server relationship to each other.

It is to be understood that the foregoing description is intended to illustrate and not to limit the scope of the invention, which is defined by the scope of the appended claims. Other embodiments are within the scope of the following claims.

What is claimed is:

1. A method for determining product recommendations to be presented to users, the method comprising:
forming, by a formula generation module, a plurality of different recommendation formulas, including, for each recommendation formula, assigning a weight to at least some of a plurality of recommendation characteristics, wherein each recommendation characteristic is representative of at least one of a characteristic of a product, a characteristic of a method for presenting the product recommendations to the users, and a characteristic of a user;
iteratively performing the steps of:
for each of the plurality of recommendation formulas, selecting, by a product recommendation module, at least one product for presentation to the users on the basis of the corresponding recommendation formula;
sending, by a communications module, instructions to a server to present the selected product to the users;
receiving, by a data evaluation module, data representative of user responses to each of the products presented to the users;
evaluating, by the data evaluation module, the received data; and
selecting, using the data evaluation module, a subset of the recommendation formulas included in the plurality of recommendation formulas on the basis of the evaluation of the collected data.

2. The method of claim 1, wherein the characteristic of the method for presenting the product recommendations to the user includes at least one of a degree of variety in the presented product recommendations, a degree of randomization of the presented product recommendations, and a degree of filtering of the presented product recommendations.

3. The method of claim 1, wherein the characteristic of a user includes at least one of a purchasing history of the user, a browsing history of the user, and a demographic characteristic of the user.

4. The method of claim 3, wherein forming the plurality of recommendation formulas includes determining a length in time of at least one of the purchasing history of the user and the browsing history of the user.

5. The method of claim 1, wherein selecting at least one product includes selecting at least one product further on the basis of a characteristic of the product.

6. The method of claim 1, wherein receiving data representative of user responses includes receiving data representative of a performance metric.

7. The method of claim 6, wherein the performance metric includes at least one of a click through rate, a click conversion rate, a click purchase rate, a click revenue, a view through conversion rate, a view through purchase rate, a click average order size, a view through average order size, a view through revenue, and a total revenue.

8. The method of claim 1, wherein evaluating the received data includes evaluating the data on the basis of a performance metric.

9. The method of claim 8, wherein the performance metric includes at least one of a click through rate, a click conversion rate, a click purchase rate, a click revenue, a view through conversion rate, a view through purchase rate, a click average order size, a view through average order size, a view through revenue, and a total revenue.

10. The method of claim 8, wherein evaluating the received data includes identifying at least one recommendation formula for which a value associated with the performance metric of the collected data corresponding to the at least one identified recommendation formula exceeds a predetermined threshold value.

11. The method of claim 10, wherein selecting the subset of the recommendation formulas including eliminating the at least one recommendation formula for which the value associated with the performance metric of the collected data corresponding to the selected at least one recommendation formula is less than the predetermined threshold value.

12. The method of claim 10, wherein the value associated with the performance metric is a confidence level representative of a relative standing of the performance metric.

13. The method of claim 8, wherein evaluating the received data includes identifying at least one recommendation formula for which the performance metric of the collected data corresponding to the identified at least one recommendation formula is below a predetermined threshold value.

14. The method of claim 1, wherein evaluating the received data includes: fitting a surface to the collected data; and smoothing the surface.

15. The method of claim 14, wherein the surface is representative of a value of a performance metric associated with each of the plurality of recommendation formulas.

16. The method of claim 1, further comprising, for each of the subset of the recommendation formulas, selecting, by the product recommendation module, at least one product for presentation to the users on the basis of the corresponding recommendation formula.

17. The method of claim 1, further comprising accepting, at the formula generation module, the plurality of recommendation characteristics.

18. A system for determining product recommendations to be presented to users, the system comprising:
a formula generation module configured to form a plurality of different recommendation formulas, including, for each recommendation formula, assigning a weight to at least some of a plurality of recommendation characteristics, wherein each recommendation characteristic is representative of at least one of a characteristic of a product, a characteristic of a method for presenting the product recommendations to the users, and a characteristic of a user;
a product recommendation module configured to select, for each of the plurality of recommendation formulas, at least one product for presentation to the users on the basis of the corresponding recommendation formula;
a communications module configured to send instructions to a server to present the selected product to the users; and
a data evaluation module configured to perform the steps of:
receiving data representative of user responses to each of the products presented to the users;
evaluating the received data; and
selecting a subset of the recommendation formulas included in the plurality of recommendation formulas on the basis of the evaluation of the collected data.
